(19) United States
(12) Patent Application Publication
(10) Pub. No.: US 2009/0146443 A1
(43) Pub. Date: Jun. 11, 2009

(54) STORAGE APPARATUS

(76) Inventor: Edward G. Guirlinger, New Albany, OH (US)

Correspondence Address: Lech Law, LLC, P.O. Box 3473, Dublin, OH, 43016, US

(21) Appl. No.: 12/246,466

(22) Filed: Oct. 6, 2008

Related U.S. Application Data
(60) Provisional application No. 60/977,552, filed on Oct. 4, 2007.

(51) Int. Cl. B60R 9/00

(52) U.S. Cl. 296/37.6; 224/274; 224/404

(57) ABSTRACT

A storage apparatus is provided. In one example embodiment, the storage apparatus may be mounted on a utility vehicle. The storage apparatus includes a lid assembly and a side door assembly.

### CROSS-REFERENCE TO RELATED APPLICATION

This application claims priority from U.S. Provisional Application No. 60/977,552, filed Oct. 4, 2007, which is incorporated by reference as if fully set forth herein.

### FIELD OF INVENTION

The present application relates to storage apparatus which may be attached to a vehicle bed. More particularly, the present application relates to a storage apparatus which may be installed on the bed of a golf car or the like.

### BACKGROUND

Certain utility vehicles have long been used to transport objects from one place to another. Maintenance personnel, such as apartment managers, amusement park technicians and airplane mechanics, for example, often need to transport tool sets from a central location to a remote job site. Typically, trucks are used to transport such personnel and tool sets. Trucks provide the durability necessary for such a task, but are often inefficient due to the size of the truck. Presently, smaller vehicles, such as golf cars and the like, are poor choices for such transportation needs because they cannot provide the stability to store the tool sets during transportation.

### BRIEF DESCRIPTION OF DRAWINGS

The accompanying figures, which are incorporated in and constitute a part of the specification, illustrate various example systems, methods, results, and so on, and are used merely to illustrate various example embodiments. It should be noted that various components depicted in the figures may not be drawn to scale, and that the various shapes (e.g., rectangular, square) depicted in the figures are presented for purposes of illustration only, and should not be considered in any way as limiting.

In the drawings and description that follow, like elements are identified with the same reference numerals. The drawings are not to scale and the proportion of certain elements may be exaggerated for the purpose of illustration.

FIG. 1 is a perspective view of one embodiment of a storage apparatus.

### DETAILED DESCRIPTION

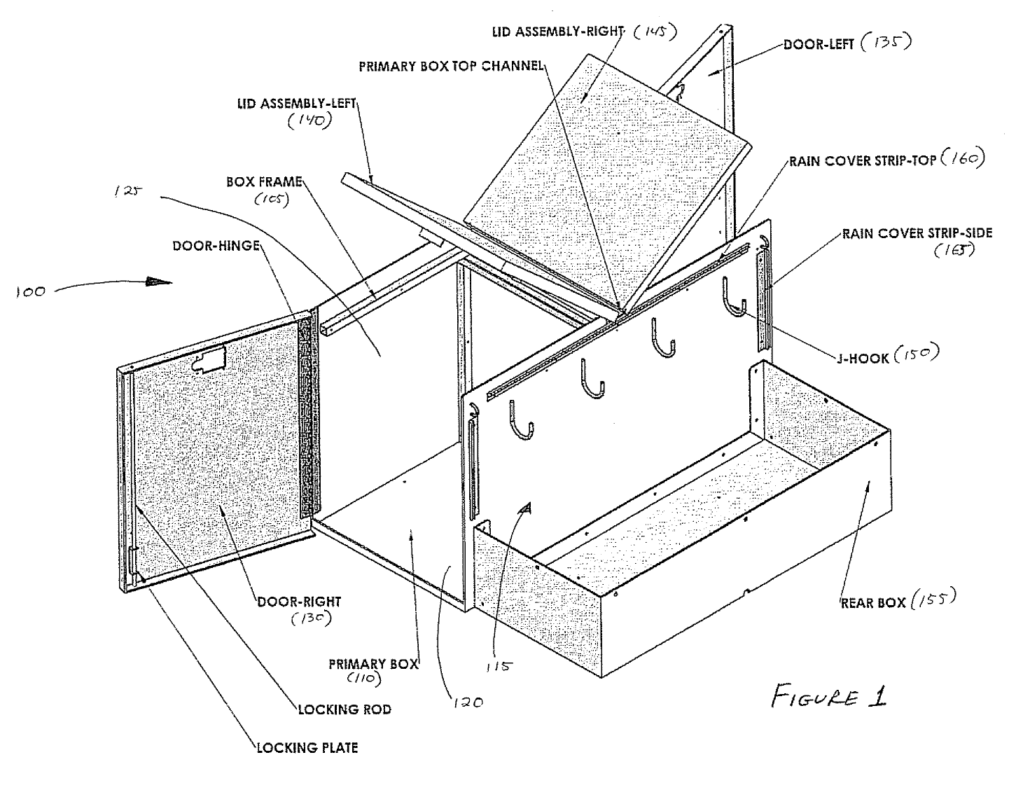

The present application is directed to a storage apparatus which may be attached to a vehicle bed. FIG. 1 is a perspective view illustrating one embodiment of an example storage apparatus 100. Although the example storage apparatus 100 is described with respect to attachment to a golf car (not shown), the storage apparatus 100 is well suited for attachment to a number of other vehicles such as, for example, a flat bed truck, a panel van and a trailer.

In the illustrated embodiment, the storage apparatus 100 is constructed around a box frame 105. The apparatus includes a primary box 110 having a rear wall 115, floor 120 and front wall 125. The storage apparatus 100 further includes a right door 130 and a left door 135 which define the sides of the apparatus 100 when the doors are in a closed configuration. The example storage apparatus further includes two lid assemblies, a left lid assembly 140 and a right lid assembly 145 which define the top of the storage apparatus 100 when the lid assemblies 140 and 145 are in a closed configuration.

For convenience, a plurality of J-hooks 150 may be attached to the rear wall 115 of the storage apparatus 100. The example storage apparatus 100 further includes a rear box 155 attached to the rear wall 115. Optionally, a flexible rain cover (not shown) may be attached to the rear wall 115 of the storage apparatus 100 using one or more rain cover strips 160 and 165 affixed to the rear wall 115 of the example storage apparatus 100. The rain cover strips 160 and 165 attach a front edge of the flexible rain cover to the rear wall 115. The rear edge of the flexible rain cover may be attached to a hinged frame (not shown). The frame provides structure to the flexible covering, and attaches to the lower side portions of the rear wall 115 or rear box 155 via a swivel or hinge mechanism. The hinged rain cover frame enables the rain cover to move between an open and closed configuration. In the closed configuration, the hinged frame is substantially parallel to the rear wall 115, allowing the flexible rain covering to gather along the rear wall 115. In the open configuration, the hinged frame extends from the lower portion of the rear wall 115 diagonally to an upper portion of the rear box 155, enabling the flexible rain cover to protect any contents of the rear box 155.

While the present application includes an illustration and description of at least one example embodiment of the storage apparatus, and while the embodiments have been described in some detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, on the illustrative embodiments shown and described. Accordingly, departures may be made from such details without departing from the spirit or scope of the applicant's general inventive concept.

Unless specifically stated to the contrary, the numerical parameters set forth in the specification are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and so on have been illustrated by describing experimental results, and while the experimental results have been described in considerable detail, it is not the intention of the applicant to restrict, or in any way, limit the scope of the appended claims to such detail. It is, of course, not possible to describe every conceivable combination of components or methodologies for purposes of describing the material components, systems, methods, and so on provided herein. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

Finally, to the extent that the term “includes” or “including” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed. 1995).

I claim:

1. A storage container for a vehicle having a cargo bed, the storage container comprising:
a frame defining a storage space, the frame including a first opposing wall, a second opposing wall, a bottom, and a connecting wall, the first opposing wall, the second opposing wall and the connecting wall each having a top edge disposed within a substantially horizontal plane, the first opposing wall, second opposing wall and bottom each having a side edge disposed within a substantially vertical plane;
a lid assembly having a first side edge hingedly attached to the top edge of the connecting wall, the lid assembly being rotatable around a first axis aligned with the top edge of the connecting wall; and
a side door assembly having a first opposing edge hingedly attached to the side edge of the first opposing wall, the side door assembly being rotatable around a second axis aligned with the side edge of the first opposing wall.

2. The storage container of claim 1, further including:
a side securing mechanism attached to the side door assembly, the attachment mechanism cooperating with the frame thereby securing the side door assembly in a closed position.

3. The storage container of claim 2, wherein the side securing mechanism includes a locking rod and a locking plate.

4. The storage container of claim 3, wherein the locking rod cooperates with the bottom to secure the side door in the closed position.

5. The storage container of claim 3, wherein the locking rod cooperates with the second opposing wall to secure the side door in the closed position.

6. The storage container of claim 1, further including:
an lid securing mechanism attached to the lid assembly, the lid securing mechanism cooperating with the side door assembly thereby securing the lid assembly in a closed position.

7. The storage container of claim 6, wherein the lid securing assembly is a hasp and plate.

8. The storage container of claim 1, wherein at least a portion of the bottom is formed by the vehicle bed.

10. The storage container of claim 1, further including a second storage space defined by a second frame attached to the second opposing wall.

11. The storage container of claim 1, further including a rain cover.

12. The storage container of claim 1, wherein the first axis is disposed about 90 degrees with respect to the second axis.

13. The storage container of claim 1, wherein the lid assembly includes a lid and a hinge.

14. A vehicle comprising:
a passenger compartment; and
a cargo bed, the cargo bed including a storage container comprising:
a frame defining a storage space, the frame including a first opposing wall, a second opposing wall, a bottom, and a connecting wall, the first opposing wall, the second opposing wall and the connecting wall each having a top edge disposed within a substantially horizontal plane, the first opposing wall, second opposing wall and bottom each having a side edge disposed within a substantially vertical plane;
a lid assembly having a first side edge hingedly attached to the top edge of the connecting wall, the lid assembly being rotatable around a first axis aligned with the top edge of the connecting wall; and
a side door assembly having a first opposing edge hingedly attached to the side edge of the first opposing wall, the side door assembly being rotatable around a second axis aligned with the side edge of the first opposing wall.

15. The vehicle of claim 14, wherein the vehicle is a golf car.

16. The vehicle of claim 14, wherein the vehicle is a truck.
